(19) United States
(12) Patent Application Publication
(10) Pub. No.: US 2019/0182456 A1
(43) Pub. Date: Jun. 13, 2019

(54) JOINT ATTENTION ESTIMATION USING STRUCTURED LIGHT

(71) Applicant: EMPIRE TECHNOLOGY DEVELOPMENT LLC, Wilmington, DE (US)

(72) Inventor: Xudong MA, Clifton Park, NY (US)

(73) Assignee: XINOVA, LLC, Seattle, NY (US)

(21) Appl. No.: 16/322,611

(22) PCT Filed: Aug. 30, 2016
(86) PCT No.: PCT/US16/49334

§ 371 Date: Feb. 1, 2019

(51) Int. Cl. H04N 7/18; H04N 5/232; G06K 9/00; G06K 9/20

(52) U.S. Cl. CPC H04N 7/181; H04N 5/23206; G06K 9/2027; G06K 9/2036; G06K 9/00718; G06K 9/00771

(57) ABSTRACT

Technologies are generally described for joint attention estimation using structured light patterns. In some examples, a structured light pattern including spatial and/or temporal variations may be projected onto an area that may contain one or more locations, objects, or personnel of interest. The spatial and/or temporal variations of the structured light pattern may encode identifiers for different regions within the area. When a video camera or other video capture device captures video data of a particular region within the area, the video data may include the structured light spatial and/or temporal variations that encode an identifier for the particular region. Subsequently, the encoded region identifier may be extracted from the video data, for example by the video capture device or a network center, and used to identify the region associated with the video data. Extracted region identifiers may be used to perform joint attention estimation in real-time.

### BACKGROUND

Unless otherwise indicated herein, the materials described in this section are not prior art to the claims in this application and are not admitted to be prior art by inclusion in this section.

In a gathering such as a sporting or social event, video cameras may be used for crowd monitoring and/or control. In such situations, video data from the video cameras may be provided to a centralized location for monitoring and real-time analysis. As the scale of the gathering increases, the number of video cameras, the amount of video data, the bandwidth needed to transmit the video data in real-time, and the processing capability needed to analyze the video data in real-time, may also increase. In some situations, the sheer volume of video data may overwhelm the available transmission bandwidth and/or the available video processing capability.

In some situations, joint attention techniques may be used to select a subset of relatively important video streams for analysis. Joint attention techniques are used to identify items, people, and/or areas that may be relatively important, and may be performed based on the number of observers associated with a particular item, person, and/or area. For example, if multiple video cameras are observing the same person, the observed person may be a potential threat and may need to be monitored carefully. One joint attention technique is pose estimation, in which the orientations of multiple video cameras are estimated based on image registration. However, pose estimation techniques may involve high computational complexity, and may not be suitable for real-time data analysis.

### SUMMARY

The present disclosure generally describes techniques to perform joint attention estimation based on structured light patterns.

According to some examples, a method is provided to perform joint attention estimation using structured light. The method may include projecting a structured light pattern onto an area, determining multiple region identifiers based on the structured light pattern, determining that a first region identifier of the region identifiers is associated with a location of interest within the area, and focusing a video capture at the location of interest based on the first region identifier.

According to other examples, a video imaging system is provided to determine physical locations associated with video data. The system may include a video capture device configured to capture a video data stream and a locator module coupled to the video capture device. The locator module may be configured to receive the video data stream, recover a structured light pattern from the video data stream, and determine a physical location associated with the video data stream based on the structured light pattern.

According to further examples, a video processing system is provided to perform joint attention estimation using structured light. The system may include a location module and a processor implemented in one or more integrated circuits (ICs). The location module may be configured to determine multiple region identifiers, where the region identifiers are based on a structured light pattern. The processor may be configured to determine that a first region identifier of the region identifiers is associated with a location of interest, and either select one or more video streams of multiple available video streams, where the one or more video streams are directed at the location of interest, or provide instructions to a video capture device to focus at the location of interest based on the first region identifier.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates how structured light may be used to determine information about a three-dimensional object;

FIG. 2 illustrates how an area may be subdivided into regions;

FIG. 3 illustrates how a structured light pattern may illuminate different regions in an area with specific and unique illumination patterns;

FIG. 4 illustrates how another structured light pattern may illuminate different regions in an area with specific and unique illumination patterns;

FIG. 5 illustrates an example system to perform joint attention estimation using region identifiers derived from a structured light pattern;

FIG. 6 illustrates a general purpose computing device, which may be used to perform joint attention estimation based on structured light patterns;

FIG. 7 is a flow diagram illustrating an example method to perform joint attention estimation based on structured light patterns that may be performed by a computing device such as the computing device in FIG. 6; and

FIG. 8 illustrates a block diagram of an example computer program product, some of which arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alfa, to methods, apparatus, systems, devices, and/or computer program products related to joint attention estimation based on structured light.

Briefly stated, technologies are generally described for joint attention estimation using structured light patterns. In some examples, a structured light pattern including spatial and/or temporal variations may be projected onto an area that may contain one or more locations, objects, or personnel of interest. The spatial and/or temporal variations of the structured light pattern may encode identifiers for different regions within the area. When a video camera or other video capture device captures video data of a particular region within the area, the video data may include the structured light spatial and/or temporal variations that encodes an identifier for the particular region. Subsequently, the encoded region identifier may be extracted from the video data, for example by the video capture device or a network center, and used to identify the region associated with the video data. These extracted region identifiers may then be used to perform joint attention estimation in real-time.

Structured light illumination is often used for noncontact surface scanning methods because of its high accuracy and scalability. Structured light illumination may involve projecting light with a particular structured pattern onto a target surface and recording the reflection of the structured light pattern from the target surface. A topology of the target surface may affect how the structured light pattern is reflected, and three-dimensional data about the target surface topology may then be extracted from the reflection of the structured light pattern.

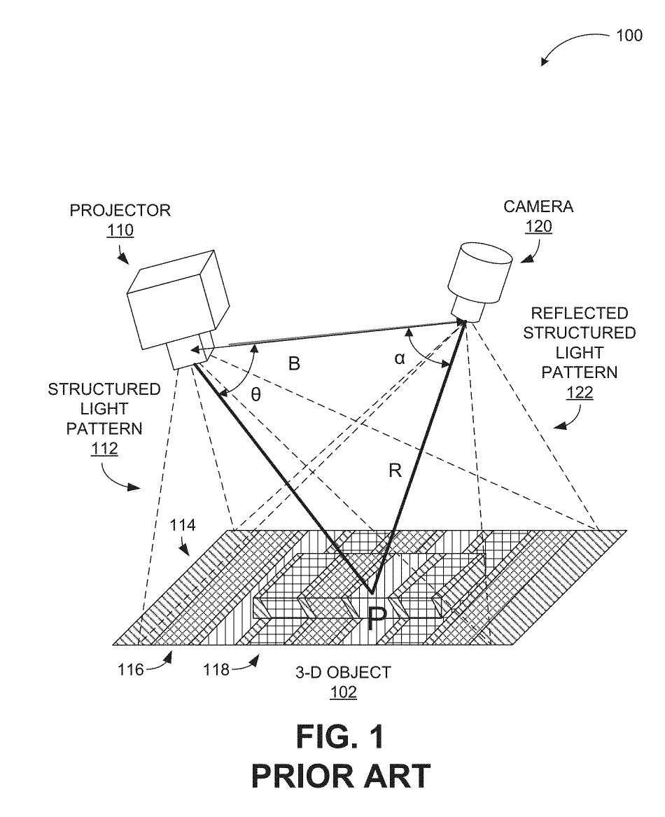

FIG. 1 illustrates how structured light may be used to determine information about a three-dimensional object.

According to a diagram 100, a projector 110 may be configured to project a structured light pattern 112 to illuminate a three-dimensional object 102. The structured light pattern 112 may have portions that differ in color, intensity, or some other measurable characteristic. For example, a first portion 114 of the structured light pattern 112 may have a different color or intensity than a second portion 116 of the structured light pattern 112. In turn, a third portion 118 of the structured light pattern 112 may have a different color or intensity than both the first portion 114 and the second portion 116. In the diagram 100, the structured light pattern 112 may be formed from a repeating combination of the portions 114, 116, and 118. However, other structured light patterns may be formed from combinations of more or fewer difference portions, and may not include repeating combinations.

A camera 120 may then be configured to capture a reflected structured light pattern 122 resulting from the reflection of the structured light pattern 112 from the three-dimensional object 102. The reflected structured light pattern 122 may include reflected light formed by the interaction of the first portion 114, the second portion 116, and the third portion 116 with the three-dimensional object 102. Information about the topology of the three-dimensional object 102 may then be recovered from the reflected structured light pattern 122, based on distance and orientation parameters associated with the projector 110, the object 102, and the camera 120. Distance parameters may include a distance B between the projector 110 and the camera 120, and a distance R between the camera 120 and a point P on the surface of the object 102. Angle parameters may include an angle θ measured between a line between the projector 110 and the camera 120 and a line between the projector 110 and the point P, and an angle α measured between the line between the projector 110 and the camera 120 and a line between the camera 120 and the point P.

As depicted in FIG. 1, the structured light pattern 112 may illuminate different regions of an area differently. For example, the leftmost portion of the illuminated area in the diagram 100 may be illuminated by the first portion 114. The portion of the illuminated area immediately to the right of the leftmost portion of the illuminated area may be illuminated by the second portion 116.

In some embodiments, structured light patterns may be specifically configured to illuminate different regions within an area differently, such that a particular region within the area can be distinguished from another region based on the structured light illumination. For example, a particular area may be subdivided into a number of regions, and a structured light pattern may be configured to illuminate the area with spatial and/or temporal variations such as each region within the area has a specific and unique (at least within the area) illumination pattern. As a result, video data captured of events occurring in a particular region may also include the specific and unique illumination pattern associated with that region, which can subsequently be extracted and used to identify the location associated with the events in the video data.

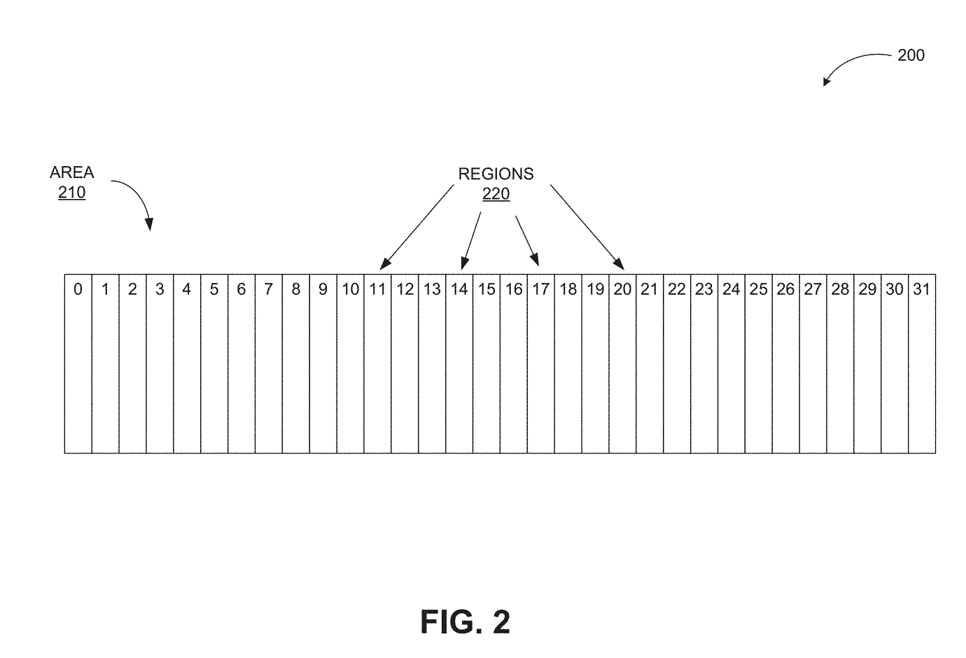

FIG. 2 illustrates how an area may be subdivided into regions, arranged in accordance with at least some embodiments described herein.

As depicted in a diagram 200, an area 210, which may be the entirety or a portion of a space to be monitored, may be subdivided along one spatial dimension of the area 210 (interchangeably referred to herein as the “length” of the area 210) into multiple regions 220. For example, the area 210 may be part of an enclosed facility such as a warehouse, a conference hall, a concert hall, an indoor arena or stadium, a meeting hall, or other similar area. The area 210 may also be an outdoor space, such as a fairground, an outdoor arena, an open stadium, or other similar area. In the diagram 200, the regions 220 include 32 separate regions, each denoted by a number. While in the diagram 200 each of the regions 220 is depicted as a slice that spans one entire dimension (interchangeably referred to herein as a “width”) of the area 210, in other embodiments a particular area to be monitored may be subdivided into regions of any size, shape, and/or orientation. For example, an area to be monitored may be subdivided into a grid of square regions, hexagon regions, overlapping circular regions, or regions with any particular shape. Different regions may have different shapes and/or sizes, and in some embodiments the subdivision of an area may be dynamic, where the number, sizes, and/or shapes of regions within the area change based on time, alert level, item or personnel density, or any suitable parameter.

As described above, a structured light pattern may be configured to illuminate the area 210 such that each of the individual regions in the regions 220 has a specific and unique illumination pattern. The structured light pattern may be configured to vary spatially and/or temporally, in a periodic or nonrepeating fashion. In one example of spatial variation, the structured light pattern may be configured to vary in intensity as a function of physical distance along one or more spatial dimension (e.g., length, width, and/or height) of the illuminated area. In another example of spatial variation, the structured light pattern may be configured to vary in color as a function of physical distance along one or more spatial dimension of the illuminated area. In one example of temporal variation, the structured light pattern may be configured to vary in intensity and/or color as a function of time over a particular time duration, and may repeat its variation or vary differently over a next time duration.

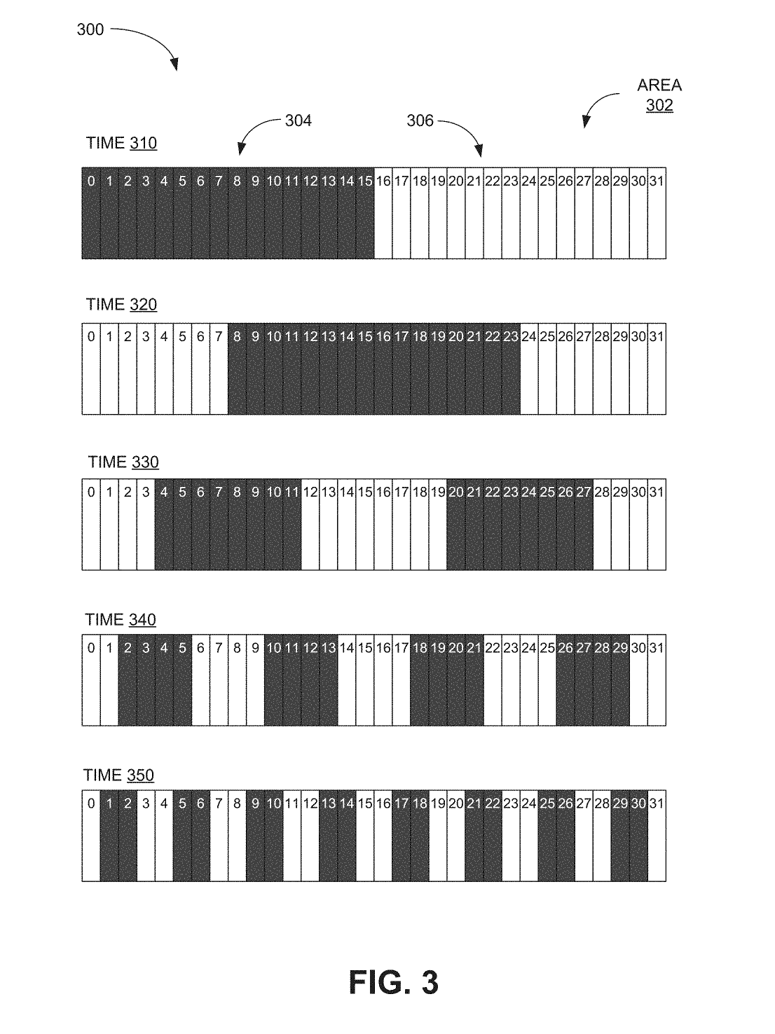

FIG. 3 illustrates how a structured light pattern may illuminate different regions in an area with specific and unique illumination patterns, arranged in accordance with at least some embodiments described herein.

According to a diagram 300, an area 302, similar to the area 210, may be divided along a length of the area 302 into 32 different regions, each denoted by a number. A structured light pattern may be projected by one or more projectors onto the area 302 and be configured to form at least one dark portion 304 and at least one light portion 306 within the area 302. The dark portion 304 may correspond to a portion of the structured light pattern that has a first light intensity, and the light portion 306 may correspond to another portion of the structured light pattern that has a second light intensity higher than the first light intensity. In some embodiments, the dark portion 304 may correspond to a portion of the structured light pattern that has zero light intensity.

The light intensity variations of the structured light pattern that form the at least one dark portion 304 and the at least one light portion 306 may be based on a function of both physical distance over the length of the area 302 and elapsed time. In some embodiments, the spatial and temporal light intensity variations of a structured light pattern may be based on a Gray coding scheme, also known as a reflected binary coding scheme. In a Gray coding scheme, which may correspond to a binary numbering scheme, data values may be represented as binary numbers, where any two consecutive binary numbers may differ by only one bit or digit. This may be accomplished by varying structured light pattern intensity as depicted in the diagram 300.

In the diagram 300, at a first time 310 the regions 0 through 15 may be illuminated by the dark portion 304, whereas the regions 16 through 31 may be illuminated by the light portion 306. At a second time 320, the regions 0 through 7 and 24 through 31 may be illuminated by the light portion(s) 306, whereas the regions 8 through 23 may be illuminated by the dark portion(s) 304. At a third time 330, the regions 0 through 3, 12 through 19, and 28 through 31 may be illuminated by the light portion(s) 306, whereas the regions 4 through 11 and 20 through 27 may be illuminated by the dark portion(s) 304. At a fourth time 340, the regions 0, 1, 6 through 9, 14 through 17, 22 through 25, 30, and 31 may be illuminated by the light portion(s) 306, whereas the other regions may be illuminated by the dark portion(s) 304. At a fifth time 350, the regions 0, 3, 4, 7, 8, 11, 12, 15, 16, 19, 20, 23, 24, 27, 28, and 31 may be illuminated by the light portion(s) 306, whereas the other regions may be illuminated by the dark portion(s) 304.

By varying structured light pattern intensity spatially and temporally as depicted in the diagram 300, each of the individual regions may be illuminated with a specific and unique pattern of light intensities. For example, region 0 has a pattern of dark (at time 310), light (at time 320), light (at time 330), light (at time 340), and light (at time 350), whereas region 1 has a pattern of dark (at time 310), light (at time 320), light (at time 330), light (at time 340), and dark (at time 350).

While the structured light pattern in FIG. 3 has intensity variations based on a Gray coding scheme, in other embodiments other intensity variation schemes that allow the intensity variations for individual regions to be adequately distinguished from each other may be used.

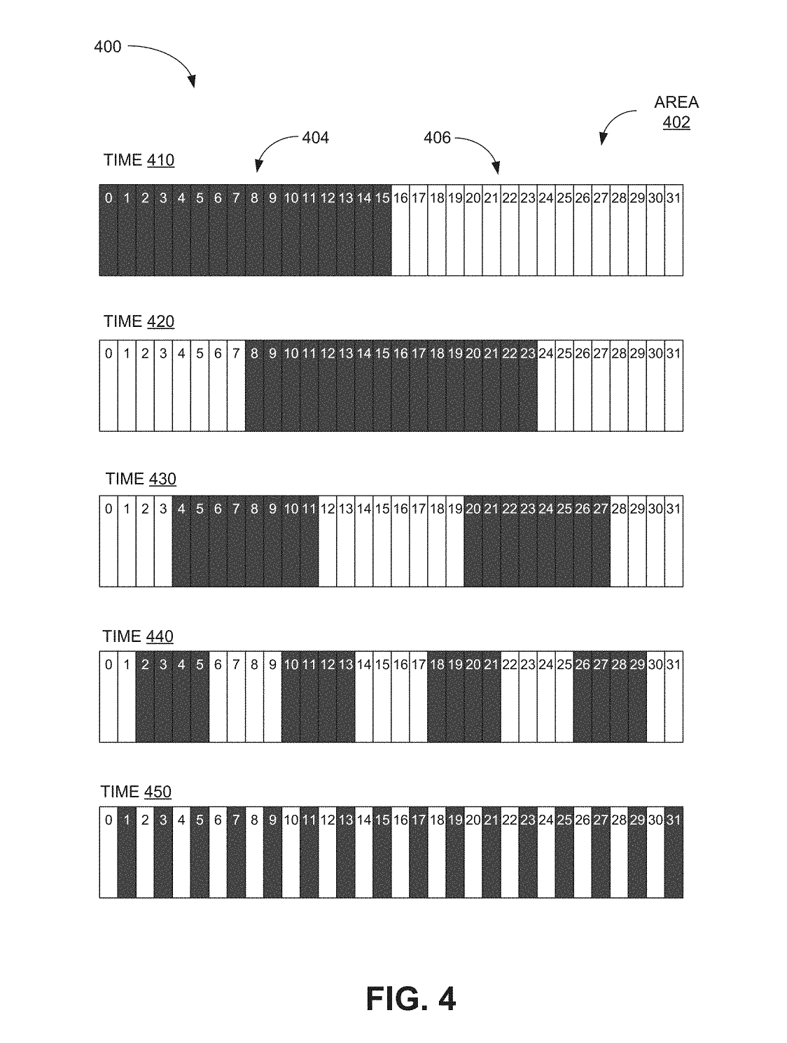

FIG. 4 illustrates how another structured light pattern may illuminate different regions in an area with specific and unique illumination patterns, arranged in accordance with at least some embodiments described herein.

According to a diagram 400, an area 402, similar to the area 302, may be divided along a length of the area 402 into 32 different regions, each denoted by a number. Similar to the diagram 300, a structured light pattern configured to form at least one dark portion 404 and at least one light portion 406 within the area 402 may be projected by one or more projectors onto the area 402.

In the diagram 400, the spatial and temporal variations of the structured light pattern may be based on a scheme similar to a Gray coding scheme as depicted in FIG. 3. In the diagram 300, at a first time 410 the regions 0 through 15 may be illuminated by the dark portion 404, whereas the regions 16 through 31 may be illuminated by the light portion 406. At a second time 420, the regions 0 through 7 and 24 through 31 may be illuminated by the light portion(s) 406, whereas the regions 8 through 23 may be illuminated by the dark portion(s) 404. At a third time 430, the regions 0 through 3, 12 through 19, and 28 through 31 may be illuminated by the light portion(s) 406, whereas the regions 4 through 11 and 20 through 27 may be illuminated by the dark portion(s) 404. At a fourth time 440, the regions 0, 1, 6 through 9, 14 through 17, 22 through 25, 30, and 31 may be illuminated by the light portion(s) 406, whereas the other regions may be illuminated by the dark portion(s) 404. At a fifth time 450, differently than the fifth time 350 in FIG. 3, the even-numbered regions (0, 2, 4, 6, etc.) may be illuminated by the light portion(s) 406, whereas the odd-numbered regions may be illuminated by the dark portion(s) 304. This scheme, while slightly different than the scheme depicted in FIG. 3, still illuminates each of the individual regions with a specific and unique pattern of light intensities.

In some embodiments, other structured light pattern parameters other than intensity may be varied to provide individual regions with specific and unique illumination patterns. For example, a structured light pattern may use color variations to provide specific and unique illumination patterns. In some embodiments, instead of using both spatial variation and intensity variation, a structured light pattern may use only spatial variation or intensity variation to provide regions with different illumination patterns.

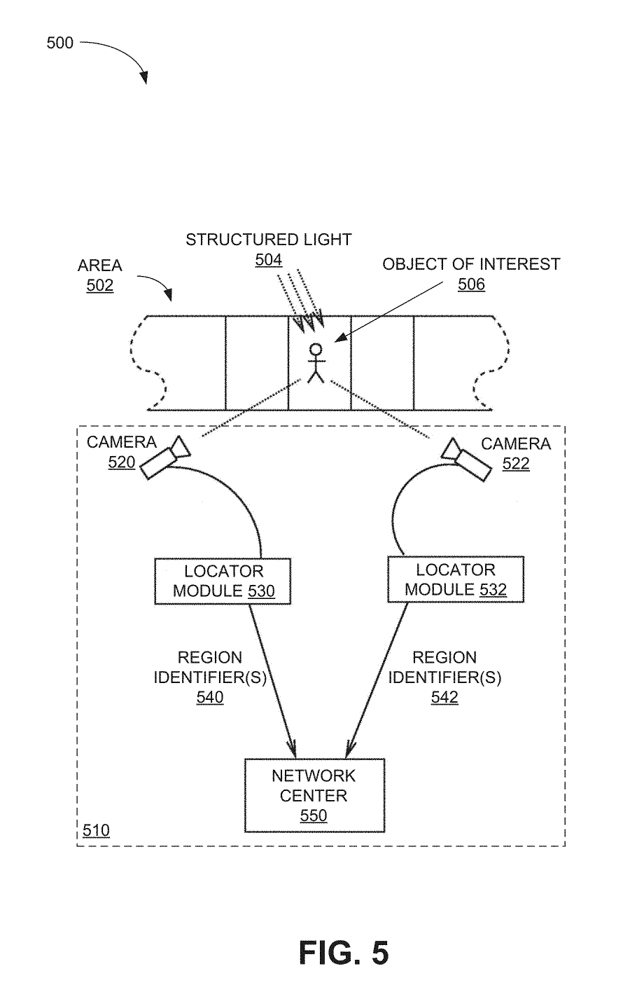

FIG. 5 illustrates an example system to perform joint attention estimation using region identifiers derived from a structured light pattern, arranged in accordance with at least some embodiments described herein.

According to a diagram 500, a system 510 may be configured to perform joint attention estimation of video data associated with an area 502, which may be similar to the area 210 described in FIG. 2. One or more projectors (not depicted), which may be part of the system 510, may be configured to project a structured light pattern 504 onto the area 502. The projector(s) may include any suitable light sources, such as lasers, light-emitting diodes (LEDs), infrared light sources, and the like, and may be configured to use any suitable structured light generation technique. The projector(s) may be stationary (for example, mounted to a stationary wall, fence, building, fixture, or other structure) or mobile (for example, mounted to some mobile object such as a person, car, motorcycle, helicopter, robot, flying drone, or any suitable manned or unmanned vehicle).

The structured light pattern 504 may be projected so as to divide the area 502 into a number of regions. In some embodiments, the structured light pattern 504 may be configured to illuminate the area 502 such that each of the individual regions in the area 502 has a specific and unique structured light illumination pattern. The structured light pattern 504 may have or be projected with spatial and/or temporal variations such that different regions are illuminated differently over a particular time duration, as described above. The spatial and/or temporal variations of the structured light pattern 504 may be based on one or more coding schemes. For example, the structured light pattern 504 may be configured to vary spatially and temporally according to a Gray coding scheme as described in FIG. 3, according to another coding scheme as described in FIG. 4, or according to any other suitable coding scheme that provides each individual region with a specific and unique structured light illumination pattern.

The system 510 may be configured to capture image and/or video data of different regions of the area 502, for example to monitor the area 502. Accordingly, the system 510 may include a camera 520, a camera 522, and optionally other cameras (not depicted), positioned and configured so as to capture video data associated with the area 502. The cameras 520/522 may be any suitable cameras or devices configured to capture still images and/or video data, and may be stationary or mobile, similar to the structured light projector(s). For example, the cameras 520/522 may be security cameras mounted to a building, fence, or pole, or may be held or worn by event or security personnel patrolling the area 502. In some embodiments, stationary cameras may be able to change their fields-of-view to capture video data associated with different regions in the area 502.

In some embodiments, each of the cameras 520/522 may be configured and/or assigned to capture video data of different regions in the area 502, for example to ensure that every region has at least one camera monitoring and/or capturing video data associated with the region. Moreover, additional mobile cameras, for example those equipped by security or event personnel, may be assigned to patrol the area 502 in order to more closely monitor events occurring in the different regions.

As the area 502 is being monitored by the system 510, an object of interest 506 may be detected. The object of interest 506 may represent an event, item, location, person, and/or any other suitable point of interest. In some embodiments, the object of interest 506 may naturally attract attention from patrolling personnel, some of who may be equipped with mobile cameras, and/or from stationary security cameras, which may be controlled and monitored by other personnel or by some monitoring agent. For example, personnel with mobile cameras may move toward and/or orient their cameras toward the object of interest 506, and the monitoring agent or personnel controlling stationary security cameras may orient one or more security cameras toward the object of interest 506. Accordingly, multiple cameras, such as the cameras 520 and 522, may begin to capture video data associated with the object of interest 506.

The video data associated with the object of interest 506 and captured by the cameras 520 and 522 may depict the object of interest 506, its activities, and its immediate environment. In addition, the video data may also include the specific and unique structured light illumination patterns associated with the region(s) within which the object of interest 506 is located and/or is nearby. Accordingly, the structured light illumination patterns included in the video data may be used to identify the particular region(s) depicted in the video data and within which the object of interest 506 is located. In some embodiments, the system 510 may include a locator module 530 coupled to the camera 520 and a locator module 532 coupled to the camera 522. The locator modules 530/532 may be configured to process the video data captured by the cameras 520/522, respectively, in order to determine structured light illumination patterns included in the respective video data. The locator modules 530/532 may then be able to identify the regions associated with the structured light illumination patterns included in the video data and thereby identify the regions depicted in the video data. For example, the locator modules 530/532 may know (for example, store or have access to) the various structured light illumination patterns associated with the different regions in the area 502. Upon determining a particular structured light illumination pattern from video data, the locator modules 530/532 may attempt to match the determined structured light illumination pattern to one of the stored/accessible structured light illumination patterns. Upon determining a match, the locator modules 530/532 may identify the region associated with the matching known structured light illumination pattern.

Upon identifying the region(s) associated with the video data, the locator modules 530/532 may transmit identifiers associated with the identified regions to a network center 550. For example, the locator module 530, upon identifying the region(s) associated with the video data captured by the camera 520, may transmit region identifier(s) 540 identifying the associated regions to the network center 550. Similarly, the locator module 532 may transmit region identifier(s) 542 identifying regions associated with the video data captured by the camera 522 to the network center 550. The locator modules 530/532 and/or the cameras 520/522 may be communicatively coupled to the network center 550 via wireless (for example, WiFi, Bluetooth, cellular, etc.) or wired (for example, Ethernet, coaxial, twisted-pair, etc.) connections.

In some embodiments, the locator modules 530/532 may not determine and transmitting region identifiers 540/542 to the network center 550. Instead, the locator modules 530/532 may extract the structured light illumination patterns associated with the video data captured by the cameras 520/522 and send the structured light illumination patterns or data representing the patterns directly to the network center 550. The network center 550 may then use the received data to identify the regions associated with the video data captured by the cameras 520/522. In other embodiments, the system 510 may not include the locator modules 530/532, and the network center 550 may receive captured video data directly from the cameras 520/522, extract the structured light illumination patterns associated with the captured video data, and identify associated regions based on the extracted patterns.

The network center 550 may then use the received region identifiers 540/542, region identifiers derived from received structured light illumination pattern data, and/or region identifiers derived from extracted structured light illumination patterns, to perform joint attention estimation. The network center 550, which may include one or more servers, processors, workstations, and/or computers, and may be automated or manned by personnel, may be coupled to multiple cameras and video capture devices, and may be configured to receive region identifiers from each of the coupled devices and/or determine region identifiers based on data received from each of the coupled devices.

The network center 550 may then perform joint attention estimation by determining whether certain regions are being monitored by multiple devices, which may indicate that objects of interest such as the object of interest 506 are present within those regions. For example, the network center 550 may know that certain devices are assigned to monitor a particular region. If the network center 550 determines, based on the received region identifiers, that other devices are also monitoring that particular region, then the network center 550 may determine that one or more objects of interest are located within that particular region. As another example, the network center 550 may determine an average number of monitoring devices per region within the area 502, for example based on previously-determined data. If the network center 550 determines that a larger-than-average number of monitoring devices are now capturing video data associated with a particular region, the network center 550 may determine that one or more objects of interest are located within that particular region. In other embodiments, any other suitable technique for joint attention estimation may be used.

In some embodiments, the network center 550 may be able to associate region identifiers to the object of interest 506 and its region in real-time or near real-time. For example, if the network center 550 receives region identifiers from coupled devices, the network center 550 may not need to devote significant processing capability to determining the locations associated with the captured video data from the coupled devices, as would be the case if techniques such as pose estimation were used. Accordingly, the network center 550 may be able to associate region identifiers to different regions and/or the object of interest 506 in real-time or substantially real-time. In some situations, the network center 550 may receive extracted structured light illumination patterns associated with captured video data instead of region identifiers. In these situations, the network center 550 may still be able to associate region identifiers to different regions and/or the object of interest 506 in real-time or substantially real-time, because relatively little processing capability may be needed to derive region identifiers from the extracted structured light illumination patterns. Finally, in cases where the network center 550 only receives the captured video data, the network center 550 may have to devote more processing capability to extracting structured light illumination patterns and deriving associated region identifiers. However, the processing capability required to extract structured light illumination patterns and derive associated region identifiers may still be less than other techniques for joint attention estimation, such as pose estimation.

Upon identifying the particular region within which an object of interest such as the object of interest 506 is located, the network center 550 may focus video capture at the particular region. For example, the network center 550 may be able to receive a set of available video streams from coupled capture devices. The network center 550 may specifically select a subset of video streams from the available video streams, where video streams in the subset are directed or oriented at the particular region within which the object of interest 506 is located. The network center 550 may also select the subset of video streams based on how much overlap the scene (for example, field-of-view) of a particular video stream has with the object of interest 506 or its region, the quality of the particular video stream, and/or the type of device that is capturing or providing the particular video stream. In some embodiments, the network center 550 may assign higher priorities to video streams from devices monitoring the object of interest 506, such as the cameras 520 and 522, than to video streams from devices monitoring one or more other regions. The higher-priority video streams associated with the object of interest 506 may then be scheduled for transmission to the network center 550 before video streams from other, lower-priority regions.

In some embodiments, the network center 550 may cause other stationary and/or mobile cameras to re-orient and capture more video data associated with the object of interest 506. The received video data associated with the object of interest 506 may then be further processed and analyzed, by the network center 550 or some other associated entity, to determine whether further action is necessary.

While in the description above region identifiers derived from structured light illumination patterns are used for joint attention estimation, in some embodiments the region identifiers may be used for other applications. For example, region identifiers associated with video data may be used to track or locate objects of interest, to reconstruct a series of events captured in video, or in any suitable application that involves locating objects of interest.

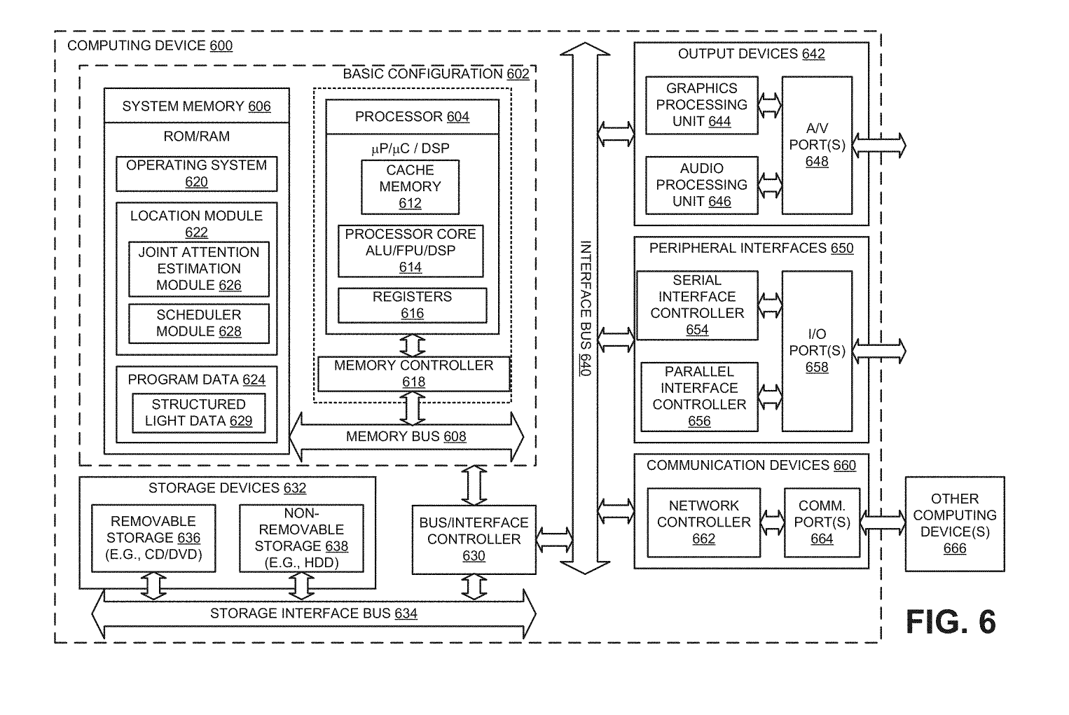

FIG. 6 illustrates a general purpose computing device, which may be used to perform joint attention estimation based on structured light patterns, arranged in accordance with at least some embodiments described herein.

For example, the computing device 600 may be used to provide joint attention estimation based on structured light as described herein. In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a location module 622, and program data 624. The location module 622 may include a joint attention estimation module 626 to perform joint attention estimation and a scheduler module 628 to assign priorities to video data as described herein. The program data 624 may include, among other data, structured light data 629 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more PO ports 658. An example communication device 660 includes a network controller 662, which may be arranged to facilitate communications with one or more other computing devices 666 over a network communication link via one or more communication ports 664. The one or more other computing devices 666 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

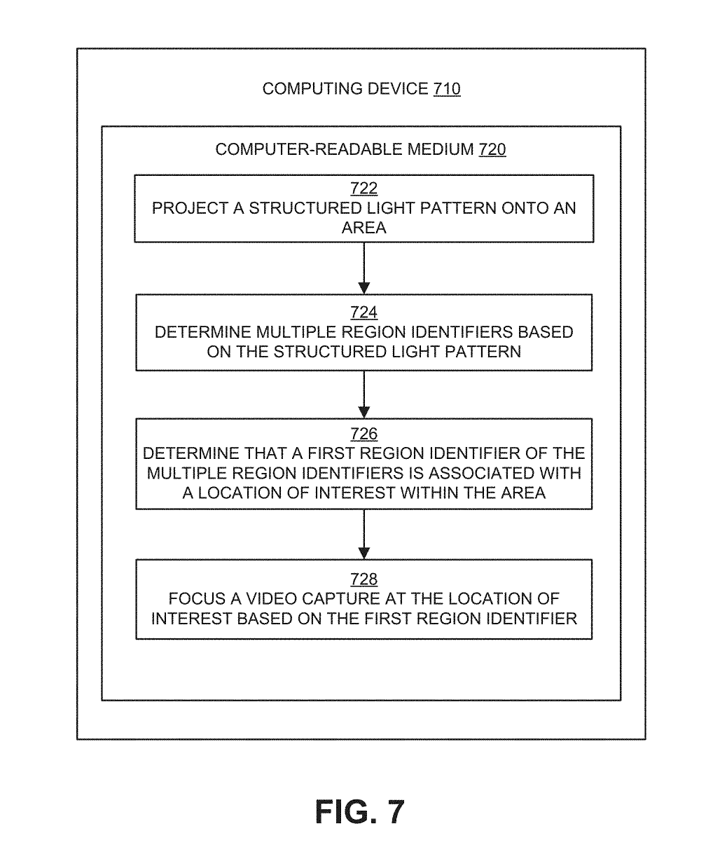

FIG. 7 is a flow diagram illustrating an example method to perform joint attention estimation based on structured light patterns that may be performed by a computing device such as the computing device in FIG. 6, arranged in accordance with at least some embodiments described herein.

Example methods may include one or more operations, functions or actions as illustrated by one or more of blocks 722, 724, 726, and/or 728, and may in some embodiments be performed by a computing device such as the computing device 600 in FIG. 6. The operations described in the blocks 722-728 may also be stored as computer-executable instructions in a computer-readable medium such as a computer-readable medium 720 of a computing device 710.

An example process to perform joint attention estimation using structured light may begin with block 722, “PROJECT A STRUCTURED LIGHT PATTERN ONTO AN AREA”, where one or more stationary or mobile projectors may be configured to project a structured light pattern onto an area to be monitored. The structured light pattern may have spatial and/or temporal variations configured to provide individual regions within the area with specific and unique illumination patterns, as described above.

Block 722 may be followed by block 724, “DETERMINE MULTIPLE REGION IDENTIFIERS BASED ON THE STRUCTURED LIGHT PATTERN”, where a locator module (for example, the locator module 530) or a network center (for example, the network center 550) may use a structured light illumination pattern captured in a video stream or video data to identify one or more regions associated with the video stream or video data. In some embodiments, the regions may be identified with one or more region identifiers, as described above.

Block 724 may be followed by block 726, “DETERMINE THAT A FIRST REGION IDENTIFIER OF THE MULTIPLE REGION IDENTIFIERS IS ASSOCIATED WITH A LOCATION OF INTEREST WITHIN THE AREA”, where the network center may use joint attention estimation to identify one or more locations of interest within the monitored area and the region identifier(s) associated with the locations of interest. For example, the network center may determine that multiple video capture devices are monitoring a particular region, or may determine that unusual numbers of video capture devices are monitoring the particular region, and may conclude that the particular region has an object or location of interest, as described above.

Block 726 may be followed by block 728, “FOCUS A VIDEO CAPTURE AT THE LOCATION OF INTEREST BASED ON THE FIRST REGION IDENTIFIER”, where the network center may focus video capture at the location of interest or associated region, for example by selecting a subset of video streams directed at the location of interest or associated region, scheduling video data associated with the location of interest or associated region with relatively high transmission priorities, and/or directing more video capture devices to capture video data of the location of interest or associated region, as described above.

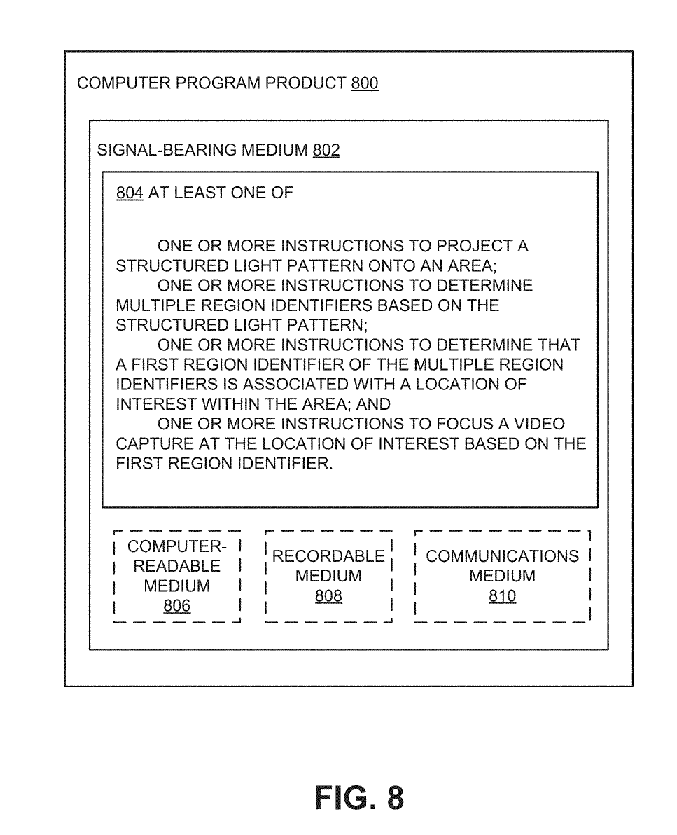

FIG. 8 illustrates a block diagram of an example computer program product, arranged in accordance with at least some embodiments described herein.

In some examples, as shown in FIG. 8, a computer program product 800 may include a signal-bearing medium 802 that may also include one or more machine readable instructions 804 that, when executed by, for example, a processor may provide the functionality described herein. Thus, for example, referring to the processor 604 in FIG. 6, the location module 622 may undertake one or more of the tasks shown in FIG. 8 in response to the instructions 804 conveyed to the processor 604 by the signal-bearing medium 802 to perform actions associated with joint attention estimation as described herein. Some of those instructions may include, for example, instructions to project a structured light pattern onto an area, determine multiple region identifiers based on the structured light pattern, determine that a first region identifier of the multiple region identifiers is associated with a location of interest within the area, and/or focus a video capture at the location of interest based on the first region identifier, according to some embodiments described herein.

In some implementations, the signal-bearing medium 802 depicted in FIG. 8 may encompass computer-readable medium 806, such as, but not limited to, a hard disk drive, a solid state drive, a compact disc (CD), a digital versatile disk (DVD), a digital tape, memory, etc. In some implementations, the signal-bearing medium 802 may encompass recordable medium 808, such as, but not limited to, memory, read/write (R/W) CDs, R/W DVDs, etc. In some implementations, the signal-bearing medium 802 may encompass communications medium 810, such as, but not limited to, a digital and/or an analog communication medium (e.g., a fiber optic cable, a waveguide, a wired communications link, a wireless communication link, etc.). Thus, for example, the program product 800 may be conveyed to one or more modules of the processor 604 by an RF signal-bearing medium, where the signal-bearing medium 802 is conveyed by a communications medium 810 (e.g., a wireless communications medium conforming with the IEEE 802.11 standard).

According to some examples, a method is provided to perform joint attention estimation using structured light. The method may include projecting a structured light pattern onto an area, determining multiple region identifiers based on the structured light pattern, determining that a first region identifier of the region identifiers is associated with a location of interest within the area, and focusing a video capture at the location of interest based on the first region identifier.

According to some embodiments, focusing the video capture at the location of interest may include selecting a subset of video streams from among multiple available video streams, where the subset of video streams may be directed at the location of interest. The method may further include selecting one or more video streams from among the subset of video streams based on an overlap of a captured scene with the location of interest, a video quality, and/or a type of device providing the video stream. In some embodiments, determining that the first region identifier is associated with the location of interest may include determining that the first region identifier is associated with the location of interest in real-time. Projecting the structured light pattern may include projecting the structured light pattern from a stationary source and/or a mobile source.

According to other embodiments, projecting the structured light pattern may include projecting the structured light pattern with a spatial variation and/or a temporal variation. Projecting the structured light pattern with the spatial variation may include projecting the structured light pattern with a variation in light intensity over a physical distance. Projecting the structured light pattern with the temporal variation may include projecting the structured light pattern with a variation in light intensity over a time duration. In some embodiments, determining the region identifiers based on the structured light pattern may include determining the region identifiers based on the temporal variation and/or the spatial variation. The temporal variation and the spatial variation may be based on a Gray coding scheme.

According to other examples, a video imaging system is provided to determine physical locations associated with video data. The system may include a video capture device configured to capture a video data stream and a locator module coupled to the video capture device. The locator module may be configured to receive the video data stream, recover a structured light pattern from the video data stream, and determine a physical location associated with the video data stream based on the structured light pattern.

According to some embodiments, the system may further include a control module configured to determine multiple region identifiers based on the structured light pattern, determine that a first region identifier of the region identifiers is associated with a location of interest, and provide instructions to the video capture device to focus at the location of interest based on the first region identifier.

According to other embodiments, the locator module may be configured to determine the physical location based on a spatial variation in the structured light pattern and/or a temporal variation in the structured light pattern. The spatial variation may include a variation in light intensity over a physical distance, and the locator module may be configured to determine the physical location based on the variation in light intensity over the physical distance. The temporal variation may include a variation in light intensity over a time duration, and the locator module may be configured to determine the physical location based on the variation in light intensity over the time duration. The temporal variation and the physical variation may be based on a Gray coding scheme. The locator module may be further configured to transmit the determined physical location to a network center.

According to further examples, a video processing system is provided to perform joint attention estimation using structured light. The system may include a location module and a processor implemented in one or more integrated circuits (ICs). The location module may be configured to determine multiple region identifiers, where the region identifiers are based on a structured light pattern. The processor may be configured to determine that a first region identifier of the region identifiers is associated with a location of interest, and either select one or more video streams of multiple available video streams, where the one or more video streams are directed at the location of interest, or provide instructions to a video capture device to focus at the location of interest based on the first region identifier.

According to some embodiments, the location module may be further configured to determine the region identifiers by receiving the region identifiers from multiple video capture devices. The processor may be further configured to assign a priority to each of the video capture devices based on the received region identifiers and schedule video data transmission from the video capture devices based on the assigned priorities. In some embodiments, the location module may be further configured to determine the region identifiers based on structured light data received from the video capture devices. The location module may be configured to determine the region identifiers based on spatial variations in the structured light data and/or temporal variations in the structured light data.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to perform joint attention estimation using structured light, the method comprising:
projecting a structured light pattern with a temporal variation onto an area;
determining a plurality of region identifiers based on the structured light pattern;
determining that a first region identifier of the plurality of region identifiers is associated with a location of interest within the area; and
focusing a video capture at the location of interest based on the first region identifier.

2. The method of claim 1, wherein focusing the video capture at the location of interest based on the first region identifier comprises selecting a subset of video streams from among a plurality of available video streams, the subset of video streams being directed at the location of interest.

3. The method of claim 2, wherein further comprising selecting one or more video streams from among the subset of video streams based on one or more of an overlap of a captured scene with the location of interest, a video quality, and a type of device providing the video stream.

4. The method of claim 1, further comprising:
projecting the structured light pattern with a spatial variation.

5. The method of claim 4, wherein projecting the structured light pattern with the spatial variation comprises projecting the structured light pattern with a variation in light intensity over a physical distance.

6. (canceled)

7. The method of claim 1, wherein projecting the structured light pattern with the temporal variation comprises projecting the structured light pattern with a variation in light intensity over a time duration.

8. The method of claim 1, wherein determining the plurality of region identifiers based on the structured light pattern comprises determining the region identifiers based on at least one of the temporal variation and a spatial variation.

9. The method of claim 1, wherein the temporal variation is based on a Gray coding scheme.

10. The method of claim 1, wherein determining that the first region identifier is associated with the location of interest comprises determining that the first region identifier is associated with the location of interest in real-time.

11. The method of claim 1, wherein projecting the structured light pattern comprises projecting the structured light pattern from at least one of a stationary source and a mobile source.

12. A video imaging system configured to determine physical locations associated with video data, the system comprising:
a video capture device configured to capture a video data stream; and
a locator module coupled to the video capture device and configured to:
receive the video data stream;
recover a structured light pattern with a temporal variation from the video data stream; and
determine a physical location associated with the video data stream based on the structured light pattern.

13. The system of claim 12, further comprising a control module configured to:
determine a plurality of region identifiers based on the structured light pattern;
determine that a first region identifier of the plurality of region identifiers is associated with a location of interest; and
provide instructions to the video capture device to focus at the location of interest based on the first region identifier.

14. The system of claim 12, wherein the locator module is configured to determine the physical location based on at least one of:
a spatial variation in the structured light pattern; and
the temporal variation in the structured light pattern.

15. The system of claim 14, wherein the spatial variation includes a variation in light intensity over a physical distance, and the locator module is configured to determine the physical location based on the variation in light intensity over the physical distance.

16. The system of claim 14, wherein the temporal variation includes a variation in light intensity over a time duration, and the locator module is configured to determine the physical location based on the variation in light intensity over the time duration.

17. The system of claim 14, wherein the temporal variation and the physical variation are based on a Gray coding scheme.

18. The system of claim 12, wherein the locator module is further configured to transmit the determined physical location to a network center.

19. A video processing system configured to perform joint attention estimation using structured light, the system comprising:
a location module configured to determine a plurality of region identifiers, wherein the plurality of region identifiers are based on a structured light pattern with a temporal variation; and
a processor implemented in one or more integrated circuits (ICs), the processor configured to:
determine that a first region identifier of the plurality of region identifiers is associated with a location of interest; and
one of:
select one or more video streams of a plurality of available video streams, the one or more video streams being directed at the location of interest, and
provide instructions to a video capture device to focus at the location of interest based on the first region identifier.

20. The system of claim 19, wherein the location module is further configured to determine the plurality of region identifiers by receiving the plurality of region identifiers from a plurality of video capture devices.

21. The system of claim 20, wherein the processor is further configured to:
assign a priority to each of the plurality of video capture devices based on the received plurality of region identifiers from the plurality of video capture devices; and
schedule video data transmission from the plurality of video capture devices based on the assigned priorities.

22. The system of claim 19, wherein the location module is further configured to determine the plurality of region identifiers based on structured light data received from the plurality of video capture devices.

23. The system of claim 22, wherein the location module is configured to determine the plurality of region identifiers based on at least one of:
spatial variations in the structured light data; and
temporal variations in the structured light data.
